(19) United States
(12) Patent Application Publication
(10) Pub. No.: US 2026/0109810 A1
(43) Pub. Date: Apr. 23, 2026

(54) TRANSIENT COPOLYMERS, PREPARATION METHODS THEREOF, AND ARTICLES COMPRISING SAID TRANSIENT COPOLYMERS

(71) Applicant: B4Plastics BV, Dilsen-Stokkem (BE)

(72) Inventors: Stefaan De Wildeman, Maasmechelen (BE); Luciano Monsegue, Maastricht (NL); Jolande Celis, Riemst (BE)

(21) Appl. No.: 18/919,783

(22) Filed: Oct. 18, 2024

(51) Int. Cl. C08G 63/91; C08G 63/183; C08G 63/85

(52) U.S. Cl. CPC C08G 63/916; C08G 63/85; C08G 63/183

(57) ABSTRACT

The present invention generally relates to a transient copolymer that can undergo chemical or biological decomposition over a predetermined period. More specifically, the present invention relates to a transient copolymer, and preparation methods thereof, comprising at least two different macromers, wherein a first macromer is a polyester; wherein a second macromer is a condensation polymer; and wherein the molar ratio of the first macromer to the second macromer is more than 4:1. The present invention further relates to an article comprising the transient copolymer and the use of a transient copolymer for preparing an article.

### FIELD OF THE INVENTION

The present invention generally relates to the field of (bio)degradable or decomposable, non-persistent polymer materials having a designable lifespan. More specifically, the present invention relates to a transient copolymer, and preparation methods thereof, comprising at least two different macromers, wherein a first macromer is a polyester; wherein a second macromer is a condensation polymer; and wherein the molar ratio of the first macromer to the second macromer is more than 4:1. The present invention further relates to an article comprising the transient copolymer and the use of a transient copolymer for preparing an article.

### BACKGROUND OF THE INVENTION

Traditional synthetic polymers such as polyethylene (PE), polypropylene (PP), and polystyrene (PS) are widely used in various industrial and consumer applications due to their desirable properties, including durability, flexibility, and low cost. However, these polymers are known to persist in the environment for extended periods due to their resistance to (natural) degradation processes. This persistence contributes to significant environmental issues, including plastic pollution, which affects ecosystems and human health. In response to these concerns, researchers and industries have increasingly turned to the development of transient, degradable polymers as a sustainable alternative.

Transient polymers are designed to break down through chemical, physical, or biological processes, converting into smaller, preferably non-toxic, intermediates to finally convert into molecules such as water, carbon dioxide, and biomass over a predetermined time frame. Various classes of transient polymers, such as biodegradable polyesters spread across different families such as alpha-hydroxy acids or beta-hydroxy acids, have been developed and are currently employed in specific applications like single-use packaging, agricultural films, and biomedical devices. Despite these advancements, challenges remain in designing degradable polymers with tailored degradation rates, in balance with optimal mechanical properties, and compatibility with existing manufacturing processes.

Existing transient polymers, such as poly(lactic acid) (PLA) and polyhydroxyalkanoates (PHAs), and poly(butylene succinate) (PBS), often exhibit limited mechanical properties, higher costs than incumbent polymers such as polyolefins, or complex manufacturing requirements that hinder their broader adoption. Furthermore, the rate and extent of degradation is often undesirable, making it difficult to achieve consistent and predictable performance. Hence, there is a growing need for innovative transient polymers, polymer compositions, and manufacturing techniques that address these limitations while offering versatility in processing and applicability.

In view of the above, it is an object of the present invention to provide innovative transient, degradable polymers and cost-effective, scalable preparation methods that result in improved material properties and controlled degradation profiles.

It is a further object of the present invention to provide and/or obtain transient polymers that can degrade in a predictable manner under specified conditions, such as exposure to moisture, enzymatic activity, or UV light. In particular, it is an object of the present invention to provide transient polymers having a designed lifespan of months to years, and preferably several years.

It is yet a further object of the present invention to provide and/or obtain transient polymers with enhanced mechanical strength, flexibility, and processability, making them suitable for a wide range of applications, including more durable applications that typically tend to wear out over time.

A further object of the present invention is to provide an article comprising said transient polymers. In addition, a further object of the present invention is to provide said article without significant adjustments to existing equipment for producing and handling said article.

### SUMMARY OF THE INVENTION

It has now been found that some or all of the above challenges can be addressed, and objectives can be achieved, either individually or in any combination, by using the specific and well-defined transient copolymers, articles, uses, and methods as defined herein.

Experimentation by the present inventors has revealed that transient copolymers comprising at least two macromers in a defined molar ratio may provide an economically viable and scalable degradable or decomposable material with an improved control over its lifespan. This advantageously allows the transient copolymer or an article comprising said transient copolymer to break down in a controlled environment, such as soil or water, within a (pre-)defined period.

Another advantage of the present transient copolymers is that they can be capable of undergoing degradation reactions upon exposure to environmental stimuli, resulting in non-toxic breakdown products.

Moreover, the transient copolymers, articles, uses, and methods as defined herein can be conveniently integrated into existing production lines without the need for significant modifications, resulting in a cost-effective solution.

Accordingly, an aspect of the present invention relates to a transient copolymer. The transient copolymer preferably comprises at least two different macromers,
wherein a first macromer is a polyester selected from the group consisting of polyethylene terephthalate, polytrimethylene terephthalate, polyethylene furanoate, polybutylene terephthalate, polybutylene succinate, polybutylene adipate terephthalate, poly(butylene succinate-co-adipate), polyethylene succinate, polybutylene adipate, and mixtures thereof;
wherein a second macromer is a condensation polymer prepared by polymerizing one or more monomers selected from the group consisting of aliphatic diols, aliphatic diamines, aliphatic dicarboxylic acids, aliphatic hydroxy acids, aliphatic amino acids and/or acetylated modifications thereof; and
wherein the molar ratio of the first macromer to the second macromer is more than 4:1, and preferably ranges between 9:2 and 50:1.

In particular embodiments, the molar ratio of the first macromer to the second macromer ranges between 5:1 and 15:1.

In particular embodiments, the second macromer is a condensation polymer prepared by polymerizing one or more aliphatic diols or aliphatic diamines comprising 3 to 36 carbon atoms, preferably 3 to 20 carbon atoms, and one or more linear aliphatic dicarboxylic acids comprising 7 to 10 carbon atoms.

In particular embodiments, the second macromer is a condensation polymer prepared by polymerizing one or more aliphatic diols or aliphatic diamines comprising 3 to 36 carbon atoms, preferably 3 to 20 carbon atoms, and one or more branched aliphatic dicarboxylic acids comprising 3 to 36 carbon atoms.

In particular embodiments, the one or more aliphatic diols are linear aliphatic diols selected from the group consisting of 1,5-pentanediol, 1,6-hexanediol, 1,7-heptanediol, 1,8-octanediol, 1,9-nonanediol, 1,10-decanediol, and mixtures thereof; and/or branched aliphatic diols selected from the group consisting of alkylated or arylated 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, and mixtures thereof.

In particular embodiments, the one or more aliphatic diamines are linear aliphatic diamines selected from the group consisting of 1,5-pentanediamine, 1,6-hexanediamine, 1,7-heptanediamine, 1,8-octanediamine, 1,9-nonanediamine and/or 1,10-decanediamine, and mixtures thereof; and/or branched aliphatic diamines selected from the group consisting of 1,5-pentanediamine, 1,6-hexanediamine, 1,7-heptanediamine, 1,8-octanediamine, 1,9-nonanediamine and/or 1,10-decanediamine, and mixtures thereof.

In particular embodiments, the one or more aliphatic dicarboxylic acids are linear aliphatic dicarboxylic acids selected from the group consisting of heptanedioic acid, octanedioic acid, nonanedioic acid, decanedioic acid, and mixtures thereof; and/or branched aliphatic dicarboxylic acids selected from the group consisting of alkylated malonic acid, alkylated succinic acid, alkylated pentanedioic acid, alkylated adipic acid, alkylated heptanedioic acid, alkylated octanedioic acid, alkylated nonanedioic acid, alkylated decanedioic acid, alkylated undecanedioic acid, alkylated dodecanedioic acid, alkylated tridecanedioic acid, alkylated hexadecanedioic, alkylated octadecanedioic acid, dimer fatty diacids, and mixtures thereof.

In particular embodiments, the one or more aliphatic hydroxy acids are selected from the group consisting of 2-hydroxy-propanoic acid, 3-hydroxy-propanoic acid, 3-hydroxy-butyric acid, 4-hydroxy-butyric acid, 3-hydroxy-pentanoic acid, 4-hydroxy-pentanoic acid, 5-hydroxy-pentanoic acid, and mixtures thereof.

In particular embodiments, the one or more aliphatic amino acids are selected from the group comprising 2-amino-propanoic acid, 3-amino-propanoic acid, 3-amino-butyric acid, 4-amino-butyric acid, 4-amino-pentanoic acid, 5-amino-pentanoic acid, 6-amino-hexanoic acid, 9-amino-stearic acid, 9-aminomethyl-stearic acid, 10-amino-stearic acid, 10-aminomethyl-stearic acid, 11-amino-undecanoic acid, 12-amino-dodecanoic acid, 12-amino-stearic acid, and mixtures thereof.

Another aspect of the present invention relates to a method for preparing a transient copolymer according to an aspect of the invention or (preferred) embodiments thereof. The method preferably comprises the steps of:
a) preparing a first macromer, wherein the first macromer is a polyester selected from the group consisting of polyethylene terephthalate, polytrimethylene terephthalate, polyethylene furanoate, polybutylene terephthalate, polybutylene succinate, polybutylene adipate terephthalate, poly(butylene succinate-co-adipate), polyethylene succinate, polybutylene adipate, and mixtures thereof;
b) preparing a second macromer by polymerizing one or more monomers selected from the group consisting of aliphatic diols, aliphatic diamines, aliphatic dicarboxylic acids, aliphatic hydroxy acids, aliphatic amino acids and/or acetylated modifications thereof;
c) contacting the first macromer and second macromer in a molar ratio of first macromer to second macromer of more than 4:1, and preferably ranging between 9:2 and 50:1, thereby obtaining the transient copolymer.

It should be understood that (preferred) embodiments of the transient copolymer according to an aspect of the present invention, and associated advantages thereof, are also (preferred) embodiments of the method for preparing said transient copolymer according to another aspect of the invention and vice versa.

In particular embodiments, step a) comprises polymerizing the corresponding monomers or depolymerization of the corresponding polyester to lower molecular weight polyester, thereby obtaining the first macromer; preferably wherein polymerizing the corresponding monomers comprises contacting ethylene glycol and/or 1,4-butanediol with one or more compounds selected from the group consisting of terephthalic acid, 2,5-furanedicarboxylic acid, succinic acid, adipic acid, or salt, ester, or anhydride derivatives thereof.

In particular embodiments, step c) comprises the steps of:
c1) heating the first macromer to a temperature of 10 to 30° C. above its softening point under inert conditions, thereby softening the first macromer;
c2) adding the second macromer to the softened first macromer; and
c3) reacting the first macromer with the second macromer.

In particular embodiments, step c3) is performed in the presence of a catalyst; and preferably wherein the catalyst is titanium (IV) butoxide or zinc acetate.

Another aspect of the present invention relates to an article comprising the transient copolymer according to an aspect of the present invention or (preferred) embodiments thereof or obtained or obtainable by means of the method according to another aspect of the present invention or (preferred) embodiments thereof. Preferably, wherein the article is a bristle, textile product, personal care product, sports product, leisure product, tire, seal, or fishing equipment.

It should be understood that (preferred) embodiments of the transient copolymer and method for preparing said transient copolymer according to aspects of the present invention, and associated advantages thereof, are also (preferred) embodiments of the article according to another aspect of the invention and vice versa.

Another aspect of the present invention relates to the use of a transient copolymer comprising at least two different macromers,
wherein a first macromer is a polyester selected from the group consisting of polyethylene terephthalate, polyethylene furanoate, polybutylene terephthalate, polybutylene succinate, polybutylene adipate terephthalate, poly(butylene succinate-co-adipate), polyethylene succinate, polybutylene adipate, and mixtures thereof;
wherein a second macromer is a condensation polymer prepared by polymerizing one or more monomers selected from the group consisting of aliphatic diols, aliphatic diamines, aliphatic dicarboxylic acids, aliphatic hydroxy acids, aliphatic amino acids and/or acetylated modifications thereof;
wherein the molar ratio of the first macromer to the second macromer is more than 4:1, and preferably ranges between 9:2 and 50:1;
   in the preparation of a bristle, textile product, personal care product, sports product, leisure product, tire, seal, or fishing equipment.

It should be understood that (preferred) embodiments of the transient copolymer, method for preparing said transient copolymer, and article comprising said transient copolymer according to aspects of the present invention, and associated advantages thereof, can be (preferred) embodiments of the use according to another aspect of the invention and vice versa.

The above and other characteristics, features and advantages of the present invention will become apparent from the following detailed description, which illustrate, by way of example, the principles of the invention.

### DETAILED DESCRIPTION OF THE INVENTION

When describing the invention, the terms used are to be construed in accordance with the following definitions, unless a context dictates otherwise.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

The discussion of the background to the invention herein is included to explain the context of the invention. This is not to be taken as an admission that any of the material referred to was published, known, or part of the common general knowledge in any country as of the priority date of any of the claims. Throughout this disclosure, various publications, patents, and published patent specifications are referenced by an identifying citation. All documents cited in the present specification are hereby incorporated by reference in their entirety. In particular, the teachings or sections of such documents herein specifically referred to are incorporated by reference.

As used herein, the singular forms “a”, “an”, and “the” include both singular and plural referents unless the context clearly dictates otherwise. By way of example, “a step” means one step or more than one step. The terms “comprising”, “comprises” and “comprised of” as used herein are synonymous with “including”, “includes” or “containing”, “contains”, and are inclusive or open-ended and do not exclude additional, non-recited members, elements, or method steps. The terms also encompass “consisting of” and “consisting essentially of”, which enjoy well-established meanings in patent terminology.

Whereas the terms “one or more” or “at least one”, such as one or more members or at least one member of a group of members, is clear per se, by means of further exemplification, the term encompasses inter alia a reference to any one of said members, or to any two or more of said members, such as, e.g., any 23, 24, 25, 26 or 27 etc. of said members, and up to all said members. In another example, “one or more”or “at least one”may refer to 1, 2, 3, 4, 5, 6, 7 or more.

The terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the disclosure described herein are capable of operation in other sequences than described or illustrated herein.

As used herein, the term “and/or” when used in a list of two or more items, means that any one of the listed items can be employed by itself or any combination of two or more of the listed items can be employed. For example, if a list is described as comprising group A, B, and/or C, the list can comprise A alone, B alone, C alone, A and B in combination, A and C in combination, B and C in combination, or A, B, and C in combination.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” or “in a particular embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while certain embodiments described herein include some but not other features included in other embodiments, combinations of features of different embodiments are meant to be within the scope of the invention, and form different embodiments, as would be understood by those in the art.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of endpoints also includes the end point values themselves (e.g. from 1.0 to 5.0 includes both 1.0 and 5.0). Any numerical range recited herein is intended to include all sub-ranges subsumed therein. This applies to numerical ranges irrespective of whether they are introduced by the expression “from . . . to . . . ” or the expression “between . . . and . . . ” or another expression.

As used herein, the terms “about” or “approximately” are used to provide flexibility to a numerical value or range endpoint by providing that a given value may be “a little above” or “a little below” said value or endpoint, depending on the specific context. Hence, the terms “about” or “approximately” as used herein when referring to a measurable value such as a parameter, an amount, a temporal duration, and the like, are meant to encompass variations of and from the specified value or endpoint, such as variations of +/−10% or less, preferably +/−5% or less, more preferably +/−1% or less, and still more preferably +/−0.1% or less of and from the specified value, insofar such variations are appropriate to perform in the disclosed invention.

Unless otherwise stated, use of the terms “about” or “approximately” in accordance with a specific number or numerical range should also be understood to provide support for such numerical terms or range without the term “about”. For example, the recitation of “about 30” should be construed as not only providing support for values a little above and a little below 30, but also for the actual numerical value of 30 as well.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. The terms “wt. %,” “vol %”, or “mol %” refers to a weight percentage of a component, a volume percentage of a component, or molar percentage of a component, respectively, based on the total weight, the total volume of material, or total moles, which includes the component.

Whenever the term “substituted” is used in the present invention, it is meant to indicate that one or more hydrogens on the atom indicated in the expression using “substituted” is replaced with a selection from the indicated group, provided that the indicated atom's normal valency is not exceeded, and that the substitution results in a chemically stable compound. Where groups can be substituted, such groups may be substituted with one or more, and preferably one, two or three substituents.

The terms described above and others used in the specification are well understood to those in the art.

In the following passages, different aspects or embodiments of the invention are defined in more detail. Each aspect or embodiment so defined may be combined with any other aspect(s) or embodiment(s) unless clearly indicated to the contrary. In particular, any feature indicated as being preferred or advantageous may be combined with any other feature or features indicated as being preferred or advantageous.

In view of the high need for innovative polymer materials that can be degraded in specific environments such as soil, water, or compost within a desirable time frame, the present inventors have found that upon combining at least a polyester component and another polycondensate component in specific molar ratios, a transient copolymer may be obtained that has a controlled lifespan, as well as good mechanical properties and processability. The present invention therefore encompasses low-persistent polymers, polymer compositions, and polymer materials that are (environmentally) decomposable and ecosystem-compatible, leading to its complete or substantial degradation within a predetermined period.

Accordingly, an aspect of the present invention relates to a transient copolymer. The transient copolymer preferably comprises at least two different macromers,
wherein a first macromer is a polyester selected from the group consisting of polyethylene terephthalate, polytrimethylene terephthalate, polyethylene furanoate, polybutylene terephthalate, polybutylene succinate, polybutylene adipate terephthalate, poly(butylene succinate-co-adipate), polyethylene succinate, polybutylene adipate, and mixtures thereof;
wherein a second macromer is a condensation polymer prepared by polymerizing one or more monomers selected from the group consisting of aliphatic diols, aliphatic diamines, aliphatic dicarboxylic acids, aliphatic hydroxy acids, aliphatic amino acids and/or acetylated modifications thereof; and
   wherein the molar ratio of the first macromer to the second macromer is more than 4:1, and preferably ranges between 9:2 and 50:1.

In what follows below, particularities and properties of the present transient copolymer and each macromer (component) are described.

The term “transient” as used herein generally refers to a temporary characteristic or state of a polymer, composition, material, or property that is intended to be present only for a predetermined duration. The transient nature may be triggered by exposure to specific environmental conditions (e.g., temperature, moisture, pH, light), chemical reactions, or biological processes, resulting in the transformation or degradation of the material such that it no longer exhibits its original form or function. For instance, a “transient copolymer” as described herein may refer to a polymeric material that degrades or decomposes under specific conditions, leading to a loss of mechanical strength or physical presence, thereby rendering it non-persistent in the environment.

Advantageously, the transient nature of the present copolymer can be engineered to occur over varying timescales, from months to years, depending on the intended application and desired environmental impact. This is in contrast to existing degradable polymers, which typically tend to decompose within a timescale of days to months.

In preferred embodiments, the present transient copolymer is a biodegradable copolymer. The term “biodegradable” used in the present context refers to a copolymer which is at least partly, in particular only partly or completely biodegradable.

The terms “(bio)degradable” and “(bio)degradation” as used herein interchangeably refer to the process of (biologically) disintegrating materials by microorganisms, such as bacteria, fungi, or other biological means into biomass and/or biogas. When the material is completely degraded, mineral components are released into the environment such as carbon dioxide, methane, water, sulfide, sulfate, ammonia, nitrite, nitrate, phosphate, and phosphite. Accordingly, a “(bio)degradable material” is a material that can be (biologically) disintegrated and mineralized by microorganisms in a period of time, such as hours, days or weeks. The (bio)degradability of a material may be primarily determined by the presence of specific enzymes produced by the present microbial community that are capable of endo-or exo-cleaving of the polymeric backbones in the respective polymeric material, liberating metabolizable carbon for building biomass and/or biogas. The biodegradability of a material can thereby be affected by a number of secondary factors that optimize the degradative capabilities by the present microbial community, such as temperature, pH, nutrients, water and oxygen. Additionally, auxiliary factors may also influence the biodegradation, which can be intrinsic to the material itself such as crystallinity, surface roughness and bioavailability of polymeric chains or their released fragments, or be dependent on environmental conditions impacting the nature of the material such as light intensity and mechanical wear, such as (oceanic) waving or shaking.

In particular embodiments, the (bio)degradability is related to the degradability of the transient copolymer in an aqueous (marine) environment.

Preferably, the transient copolymer according to the present invention is a transient copolymer being biodegradable, in particular hydrolysable, to low molecular and naturally occurring compounds such as water, carbon dioxide and the like.

In particular embodiments, the additional use of biodegradation promoting additives is advantageously dispensable. Thus, the transient copolymer is preferably free of any biodegradation promoting additives.

Preferably, the transient copolymer according to the present invention is a copolymer being chemically recyclable, in particular the transient copolymer is capable of reproducing its original constituting monomers through chemical reactions. For instance, chemical recycling of the copolymer may comprise depolymerization methods such as glycolysis, hydrolysis, and methanolysis.

The present transient copolymer is characterized in that it comprises at least two distinct macromer units, which may each contribute to the structural features of the copolymer. In other words, the present copolymer is a macromer-based copolymer and is obtainable by copolymerization of at least two macromers, wherein each macromer is a polymerizable macromolecule possessing one or more reactive sites that enable its corporation into the copolymer backbone. Hence, the repeating units (i.e., a part or segment of the copolymer that is repeated multiple times within the main chain) of the present transient copolymer are derived from at least two different macromers. Said macromers may be arranged in a linear configuration such as a block, segmented, random, statistical, or alternating configuration. Alternatively, said macromers may be arranged in a branched configuration such as a graft or star configuration. However, the present transient copolymer is not limited to a particular configuration and encompasses various other polymeric architectures.

In preferred embodiments, the transient copolymer is a thermoplastic polymer. This has the advantage that the copolymer can be molded and shaped into various forms. Further, the transient copolymer may preferably be a not cross-linked or not cross-linkable copolymer or may preferably be not in a cross-linked condition. This has the advantage that the transient copolymer can be molded and shaped into various forms.

The term “macromer” as used herein has a well-established meaning within the art and is used herein as such. More particularly, a macromer generally refers to a large, polymeric molecule or macromolecule with functional groups that allow it to participate in a polymerization reaction. In the context of the present invention, each macromer acts as a building block or unit of the copolymer. Each distinct macromer may vary in molecular weight, chemical structure, and/or reactivity.

The first macromer as described herein is a polyester selected from a specified group of polymer compounds. The term “polyester” as used herein has a well-established meaning within the art and is used herein as such. More particularly, a polyester generally refers to a class of polymers characterized by the presence of repeating ester functional groups-(CO-O)-n within their main polymer backbone. The term encompasses a wide range of structures, including linear or branched configurations, and includes both homopolyesters and copolyesters.

In the context of the present invention, suitable polyesters are or include polyethylene terephthalate (PET), polytrimethylene terephthalate, polyethylene furanoate (PEF), polybutylene terephthalate (PBT), polybutylene succinate (PBS), polybutylene adipate terephthalate (PBAT), poly(butylene succinate-co-adipate) (PBSA), polyethylene succinate (PES), polybutylene adipate (PBAG), or mixtures thereof. Preferably, the polyester is PET and/or PBT.

The first macromer may further encompass blends of polyesters such as a blend of polyethylene terephthalate (PET) and polybutylene terephthalate (PBT), polybutylene adipate terephthalate (PBAT) or polybutylene succinate (PBS), or mixed blends thereof.

The second macromer as described herein is a condensation polymer prepared by polymerizing one or more monomers selected from a specified list of monomer compounds. The term “condensation polymer” as used herein as a well-established meaning within the art and is used herein as such. More particularly, a condensation polymer generally refers to a polymer formed through a polymerization reaction involving the stepwise combination of monomer units with the concurrent elimination of a small byproduct molecule, such as water or alcohol (e.g., methanol or ethanol). In the context of the present invention, said reaction occurs between monomers containing two reactive functional groups, such as alcohol, ester, carboxylic acid, or amine groups.

The person skilled in the art understands that the condensation polymer as described herein is obtained by combining suitable monomers, and therefore rules out combinations which would be illogical or not make technical sense. In other words, monomers comprising nucleophilic functional groups can react with monomers comprising electrophilic groups. More specifically, the second macromer may be synthesized from a variety of monomer combinations, such as dicarboxylic acids with diols (yielding polyester), dicarboxylic acids with diamines (yielding polyamides). Alternatively, the second macromer may be synthesized from a single monomer type such as hydroxy acids comprising both nucleophilic hydroxy groups, which can react with electrophilic acid groups, thereby yielding polyester. The same reasoning applies mutatis mutandis to amino acids.

Preferably, the one or more monomers are aliphatic monomers. The term “aliphatic” as used herein has a well-established meaning within the art and is used herein as such. More particularly, the term generally refers to a class of organic compounds or structural segments within a molecule characterized by the presence of straight-chain, branched-chain, or cyclic (non-aromatic) arrangements of carbon atoms. In the context of the present invention, aliphatic monomers do not contain aromatic ring structures and can include saturated hydrocarbons (alkanes), unsaturated hydrocarbons (alkenes and alkynes), as well as substituents such as alcohols, carboxylic acids, or amines attached to the aliphatic backbone.

In particular embodiments, the second macromer is a condensation polymer prepared by polymerizing one or more aliphatic diols comprising 3 to 36 carbon atoms, preferably 3 to 20 carbon atoms, and one or more linear aliphatic dicarboxylic acids comprising 7 to 10 carbon atoms. As referred to herein “aliphatic diol” refers to aliphatic compounds containing two hydroxyl (—OH) groups. As referred to herein “aliphatic dicarboxylic acid” refers to aliphatic compounds containing two carboxyl (—COOH) groups.

In particular embodiments, the second macromer is a condensation polymer prepared by polymerizing one or more or aliphatic diamines comprising 3 to 36 carbon atoms, preferably 3 to 20 carbon atoms, and one or more linear aliphatic dicarboxylic acids comprising 7 to 10 carbon atoms. As referred to herein “aliphatic diamine” refers to aliphatic compounds containing two amino groups. Said amino groups may be primary amino groups and/or secondary amino groups, and preferably primary amino groups.

In particular embodiments, the second macromer is a condensation polymer prepared by polymerizing one or more aliphatic diols comprising 3 to 36 carbon atoms, preferably 3 to 20 carbon atoms, and one or more branched aliphatic dicarboxylic acids comprising 3 to 36 carbon atoms.

In particular embodiments, the second macromer is a condensation polymer prepared by polymerizing one or more aliphatic diamines comprising 3 to 36 carbon atoms, preferably 3 to 20 carbon atoms, and one or more branched aliphatic dicarboxylic acids comprising 3 to 36 carbon atoms. In particular embodiments, the second macromer is a condensation polymer prepared by polymerizing one or more monomer chosen from a linear aliphatic diol or diamine comprising 3 to 20 carbon atoms, a linear aliphatic dicarboxylic acid comprising 7 to 10 carbon atoms, a branched aliphatic diol or diamine comprising 3 to 36 carbon atoms, preferably 3 to 20 carbon atoms,, a branched aliphatic dicarboxylic acid comprising 3 to 36 carbon atoms, an aliphatic hydroxy acid comprising 2 to 5 carbon atoms, an aliphatic amino acid comprising 3 to 36 carbon atoms, preferably 3 to 20 carbon atoms, and/or acetylated modifications thereof.

More in particular the condensation polymer may be prepared by polymerizing a linear aliphatic diol or diamine comprising 3 to 12 carbon atoms, preferably 3, 4, 5, 6, 7, 8, 9, 10, 11 or 12 carbon atoms, with a linear aliphatic dicarboxylic acid comprising 7 to 10 carbon atoms, preferably 7, 8, 9 or 10 carbon atoms.

More in particular the condensation polymer may be prepared by polymerizing a branched aliphatic diol or diamine comprising 3 to 12 carbon atoms, preferably 3, 4, 5, 6, 7, 8, 9, 10, 11 or 12 carbon atoms, and/or acetylated modifications thereof, the acetylated modifications preferably being chosen from acetylated polyols such as sorbitol, with a linear aliphatic dicarboxylic acid comprising 7 to 10 carbon atoms, preferably 7, 8, 9 or 10 carbon atoms.

More in particular the condensation polymer may be prepared by polymerizing a linear aliphatic diol or diamine comprising 3 to 12 carbon atoms, preferably 3, 4, 5, 6, 7, 8, 9, 10, 11 or 12 carbon atoms, with a branched aliphatic dicarboxylic acid comprising 3 to 36 carbon atoms, preferably 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, or 36 carbon atoms, and/or acetylated modifications thereof, the acetylated modifications preferably being chosen from acetylated dicarboxylates such as tartaric acid and galactaric acid.

More in particular the condensation polymer may be prepared by polymerizing a branched aliphatic diol or diamine comprising 3 to 12 carbon atoms, preferably 3, 4, 5, 6, 7, 8, 9, 10, 11 or 12 carbon atoms, and/or acetylated modifications thereof, the acetylated modifications preferably being chosen from acetylated polyols such as sorbitol, with a branched aliphatic dicarboxylic acid comprising 3 to 36 carbon atoms, preferably 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, or 36 carbon atoms, and/or acetylated modifications thereof, the acetylated modifications preferably being chosen from acetylated dicarboxylates such as tartaric acid and galactaric acid.

More in particular the condensation polymer may be prepared by polymerizing an aliphatic hydroxy acid comprising 2 to 5 carbon atoms, preferably 2, 3, 4 or 5 carbon atoms, and/or acetylated modifications thereof. As referred to herein “aliphatic hydroxy acid” refers to a hydroxy acid containing an aliphatic side chain functional group.

More in particular the condensation polymer may be prepared by polymerizing an aliphatic amino acid comprising 2 to 36 carbon atoms, preferably 33, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, or 36 carbon atoms, and/or acetylated modifications thereof, the acetylated modifications preferably being chosen from acetylated amino acids such as dihydroxy-lysine. As referred to herein “aliphatic amino acid” refers to an aliphatic amino acid containing a side chain functional group.

In particular embodiments, the one or more aliphatic diols are linear aliphatic diols selected from the group consisting of 1,5-pentanediol, 1,6-hexanediol, 1,7-heptanediol, 1,8-octanediol, 1,9-nonanediol, 1,10-decanediol, and mixtures thereof; and/or branched aliphatic diols selected from the group consisting of alkylated or arylated 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, and mixtures thereof.

In particular embodiments, the one or more aliphatic diamines are linear aliphatic diamines selected from the group consisting of 1,5-pentanediamine, 1,6-hexanediamine, 1,7-heptanediamine, 1,8-octanediamine, 1,9-nonanediamine and/or 1,10-decanediamine, and mixtures thereof; and/or branched aliphatic diamines selected from the group consisting of 1,5-pentanediamine, 1,6-hexanediamine, 1,7-heptanediamine, 1,8-octanediamine, 1,9-nonanediamine and/or 1,10-decanediamine, and mixtures thereof.

In particular embodiments, the one or more aliphatic dicarboxylic acids are linear aliphatic dicarboxylic acids selected from the group consisting of heptanedioic acid, octanedioic acid, nonanedioic acid, decanedioic acid, and mixtures thereof; and/or branched aliphatic dicarboxylic acids selected from the group consisting of alkylated malonic acid, alkylated succinic acid, alkylated pentanedioic acid, alkylated adipic acid, alkylated heptanedioic acid, alkylated octanedioic acid, alkylated nonanedioic acid, alkylated decanedioic acid, alkylated undecanedioic acid, alkylated dodecanedioic acid, alkylated tridecanedioic acid, alkylated hexadecanedioic, alkylated octadecanedioic acid, dimer fatty diacids, and mixtures thereof.

In particular embodiments, the one or more aliphatic hydroxy acids are selected from the group consisting of 2-hydroxy-propanoic acid, 3-hydroxy-propanoic acid, 3-hydroxy-butyric acid, 4-hydroxy-butyric acid, 3-hydroxy-pentanoic acid, 4-hydroxy-pentanoic acid, 5-hydroxy-pentanoic acid, and mixtures thereof.

In particular embodiments, the one or more aliphatic amino acids are selected from the group comprising 2-amino-propanoic acid, 3-amino-propanoic acid, 3-amino-butyric acid, 4-amino-butyric acid, 4-amino-pentanoic acid, 5-amino-pentanoic acid, 6-amino-hexanoic acid, 9-amino-stearic acid, 9-aminomethyl-stearic acid, 10-amino-14 stearic acid, 10-aminomethyl-stearic acid, 11-amino-undecanoic acid, 12-amino-dodecanoic acid, 12-amino-stearic acid, and mixtures thereof.

As mentioned above, it has been found by the present inventors that combining the first macromer and second macromer in a molar ratio of first macromer to second macromer of more than 4:1 provides a transient copolymer that has a controlled lifespan, as well as good mechanical properties and processability.

In preferred embodiments, the molar ratio of the first macromer to the second macromer ranges between 9:2 and 50:1, or between 9:2 and 45:1, or between 9:2 and 40:1, or between 9:2 and 35:1, or between 9:2 and 30:1, or between 9:2 and 29:1, or between 9:2 and 28:1, or between 9:2 and 27:1, or between 9:2 and 26:1, or between 9:2 and 25:1, or between 9:2 and 24:1, or between 9:2 and 23:1, or between 9:2 and 22:1, or between 9:2 and 21:1, or between 9:2 and 20:1, or between 9:2 and 19:1, or between 9:2 and 18:1, or between 9:2 and 17:1, or between 9:2 and 16:1, preferably between 9:2 and 15:1.

In preferred embodiments, the molar ratio of the first macromer to the second macromer ranges between 9:2 and 50:1, or between 5:1 and 50:1, or between 6:1 and 50:1, or between 7:1 and 50:1, or between 8:1 and 50:1, or between 9:1 and 50:1, or between 10:1 and 50:1, or between 15:1 and 50:1, or between 20:1 and 50:1, or between 25:1 and 50:1, or between 30:1 and 50:1, or between 35:1 and 50:1, or between 40:1 and 50:1.

In particular embodiments, the transient copolymer may have a mechanical strength, in particular tensile strength, determined according to ASTM D2256 (filaments) and ASTM D638 (bars), of greater than 10 MPa, or greater than 20 MPa, or greater than 30 MPa, or from 50 MPa to 500 MPa, or 75 MPa to 500 MPa, or 75 MPa to 400 MPa, or 75 MPa to 300 MPa, or 75 MPa to 250 MPa, or 100 MPa to 250 MPa, or 100 MPa to 200 MPa. The copolymer may therefore advantageously exhibit adequate mechanical strength to meet the demands of various applications, including applications that use conventional non-degradable polymers.

In particular embodiments, the transient copolymer may have an elongation at break, determined according to ASTM D2256 (filaments) and ASTM D638 (bars), of greater than 100%, or greater than 150%, or greater than 200%, or from 200% to 1000%, or from 200% to 900%, or from 200% to 800%, or from 200% to 700%.

The present transient copolymer may be amorphous or semi-crystalline. In particular embodiments, the transient copolymer may have a glass transition temperature (T_{g}) ranging from −100° C. to 100° C., or from −75° C. to 100° C., or from −50° C. to 100° C., as determined by differential scanning calorimetry (DSC).

In the event that the transient copolymer is semi-crystalline, the transient copolymer may have a melting temperature (Tm) of between 60° C. and 260° C., or between 70° C. and 260° C., or between 80° C. and 260° C., or between 90° C. and 260° C., or between 100° C. and 260° C., wherein the Tm is taken as the maximum of the melting endotherm of a DSC thermogram.

In some embodiments, the transient copolymer may have a relative viscosity, determined according to ASTM 789-19, of greater than 0.6, or greater than 0.7, or greater than 0.8, or greater than 0.9, or greater than 1.0, or from 1.5 to 6.0, or from 1.5 to 4.5, or from 2.0 to 4.0.

In some embodiments, the transient copolymer may have an inherent viscosity, determined according to ASTM D4603-18, of greater than or equal to 0.6 dL/g, or greater than or equal to 0.7 dL/g, or greater than or equal to 0.8 dL/g, or from 0.6 dL/g to 1.5 dl/g, or from 0.7 dL/g to 1.5 dL/g, or from 0.8 dL/g to 1.0 dL/g.

In particular embodiments, the transient copolymer may have a number average molecular weight (Mₙ), determined according to ASTM D5296, of at least 20 kDa, or at least 30 kDa, or at least 35 kDa, or at least 40 kDa, or at least 50 kDa, or from at least 50 kDa to at most 500 kDa, or at least 50 kDa to at most 100 kDa. Due to the high molecular weight, the copolymer according to the present invention is advantageously suitable for most thermoplastic manufacturing methods as for example extrusion, injection molding and blow molding. Despite the relatively high molecular weight, there is a fine-tuned and in particular application-dependent balance between biodegradability and mechanical strength of the copolymer achievable.

In particular embodiments, the transient copolymer may have a durometer shore A hardness ranging from 30 to 95, preferably between 60 and 80, as determined according to ASTM D2240.

The present invention further encompasses a polymer composition, wherein the polymer composition comprises the transient copolymer according to an aspect of the present invention or (preferred) embodiments thereof; and at least one further (co)polymer or additive. For example, two transient copolymers as disclosed herein having different molecular weights can be blended to optimize desired physical properties. For another example, two transient copolymers as disclosed herein comprising at least two different macromers can be blended to provide desired physical and/or chemical properties. For even another example, a transient copolymer as disclosed herein can be blended with another (co)polymer that is not a transient copolymer as disclosed herein to provide desired physical and/or chemical properties.

Another aspect of the present invention relates to a method for preparing a transient copolymer according to an aspect of the invention or (preferred) embodiments thereof. The method preferably comprises the steps of:
a) preparing a first macromer, wherein the first macromer is a polyester selected from the group consisting of polyethylene terephthalate, polytrimethylene terephthalate, polyethylene furanoate, polybutylene terephthalate, polybutylene succinate, polybutylene adipate terephthalate, poly(butylene succinate-co-adipate), polyethylene succinate, polybutylene adipate, and mixtures thereof;
b) preparing a second macromer by polymerizing one or more monomers selected from the group consisting of aliphatic diols, aliphatic diamines, aliphatic dicarboxylic acids, aliphatic hydroxy acids, aliphatic amino acids and/or acetylated modifications thereof;
c) contacting the first macromer and second macromer in a molar ratio of first macromer to second macromer of more than 4:1, and preferably ranging between 9:2 and 50:1, thereby obtaining the transient copolymer.

It should be understood that (preferred) embodiments of the transient copolymer according to an aspect of the present invention, and associated advantages thereof, are also (preferred) embodiments of the method for preparing said transient copolymer according to another aspect of the invention and vice versa.

Preparing the first macromer in step a) of the present method may comprise synthesizing said macromer by polymerizing the corresponding monomers or depolymerizing the corresponding polymer. For instance, in the event that the first macromer is polyethylene terephthalate (PET) said macromer may be prepared by polymerizing ethylene glycol and terephthalic acid or a salt, ester, or anhydride derivative thereof. Alternatively, said macromer may be prepared by depolymerizing a polyethylene terephthalate (PET) having a higher molecular weight.

In particular embodiments, step a) comprises polymerizing the corresponding monomers or depolymerization of the corresponding polyester to lower molecular weight polyester, thereby obtaining the first macromer; preferably wherein polymerizing the corresponding monomers comprises contacting ethylene glycol, 1,3-propanediol, and/or 1,4-butanediol with one or more compounds selected from the group consisting of terephthalic acid, 2,5-furanedicarboxylic acid, succinic acid, adipic acid, or salt, ester, or anhydride derivatives thereof.

The skilled person understands how to polymerize the corresponding monomers or depolymerize the corresponding polyester to lower molecular weight polyester to obtain the first macromer. In what follows suitable, non-limiting conditions are described for each process of preparing the first macromer.

Suitable polymerization conditions include mixing the respective monomers (e.g., using a horizontal or vertical mixer), and heating the resulting monomer mixture to a temperature of from 160° C. to 280° C. until a desired degree of conversion is reached. Polymerization of the respective monomers may be performed under a reduced pressure (e.g., from 13.3 Pa to 1333.2 Pa) to facilitate the removal of condensate by-product. Esterification catalyst may further be added such as zinc acetate, or titanium-based catalysts (e.g., titanium alkoxide) to increase reaction rates. The molecular weight of the resulting polymer is controlled by adjusting the reaction time, temperature, and pressure conditions. The intrinsic viscosity of the formed polyester can be monitored to ensure the desired properties are achieved.

Depolymerization as described herein involves chemical processes that break the polymer chains of a starting polyester into smaller polymers or oligomers of lower molecular weight. Suitable depolymerization techniques include glycolysis, hydrolysis, and methanolysis of the respective polyester. Metal-based catalysts, such as zinc acetate, antimony trioxide (Sb₂O₃), or manganese acetate, can be used to accelerate the depolymerization reaction. Depolymerization may be carried out at temperatures ranging from 150° C. to 260° C. until a desired degree of conversion is reached.

Preparing the second macromer in step b) of the present method comprised synthesizing said macromer by polymerizing the corresponding monomers selected from the group of listed monomers above. The same polymerization conditions as described herein above for the first macromer may be used for preparing the second macromer.

In particular embodiments, step c) comprises the steps of:
c1) heating the first macromer to a temperature of 10 to 30° C. above its softening point under inert conditions, thereby softening the first macromer;
c2) adding the second macromer to the softened first macromer; and
c3) reacting the first macromer with the second macromer.

The “softening point” of the first macromer, as used in this specification, denotes the temperature at which a polymeric material begins to exhibit significant plastic deformation or flow under an applied load or specific testing conditions. This temperature can be measured using techniques such as the Vicat softening temperature test (ASTM D1525) or the ring-and-ball method (ASTM E28), depending on the nature of the polymer. The softening point is distinct from the glass transition temperature (T_{g}) and melting temperature (Tₘ) of the polymer, as it represents the temperature range in which the material becomes soft and pliable, but does not fully melt.

In particular embodiments, step c3) is performed in the presence of a catalyst; and preferably wherein the catalyst is titanium (IV) alkoxide (e.g., titanium (IV) butoxide) or zinc acetate.

The present invention further encompasses a transient copolymer obtained or obtainable by carrying out the method as disclosed herein.

As mentioned above, the copolymer as disclosed herein, or obtained or obtainable by carrying out the method as disclosed herein, can be particularly useful for the manufacture of various products or articles.

Accordingly, another aspect of the present invention relates to an article comprising the transient copolymer according to an aspect of the present invention or (preferred) embodiments thereof or obtained or obtainable by means of the method according to another aspect of the present invention or (preferred) embodiments thereof. Preferably, wherein the article is a bristle, textile product, personal care product, sports product, leisure product, tire, seal, or fishing equipment.

It should be understood that (preferred) embodiments of the transient copolymer and method for preparing said transient copolymer according to aspects of the present invention, and associated advantages thereof, are also (preferred) embodiments of the article according to another aspect of the invention and vice versa.

In some embodiments, at least a part of the surface of the article may consist of the transient copolymer. Preferably, the entire surface of the article consists of the transient copolymer.

In some embodiments, at least a part of the bulk of the r article may consist of the transient copolymer. The article of the present invention is not limited to a particular shape or design. For instance, the article may have an elongated shape. Alternatively, the article may have a rectangular shape. For application, the transient copolymer may be formed into at least a part of the article as described herein by utilizing melt forming techniques such as compression, extrusion, blow molding, injection molding and the like.

Preferably, the article is an article being exposed or exposable to moisture and/or water. With respect to such articles, the transient copolymer according to the invention is especially advantageous in as much as the inventive transient copolymer allows for adjusting a fine balance between (bio)degradation behaviour and mechanical strength, which is a prerequisite for the applicability of such articles.

The article, apart from the transient copolymer according to an aspect of the invention, may be free of any further (co)polymer. Furthermore, the article may be free of a plasticizer and/or degradation promoting additive and/or fibers, in particular natural fibers such as cellulose or starch fibers.

Furthermore, the article may comprise an additive, in particular a non-polymeric additive. The additive is preferably selected from the group consisting of a salt, a colorant and combinations of at least two of the aforesaid additives.

The salt may be selected from the group consisting of ammonium salt, phosphate, sodium salt, potassium salt and mixtures of at least two of the aforesaid salts. The colorant may be for example a masterbatch, i.e. a color concentrate, in particular a biodegradable masterbatch. A respective masterbatch is, for example, commercially available under the name PolyOne (Avient).

Further, the article is preferably compostable, preferably under environmental conditions, in particular at a temperature of 10° C. to 40° C., in particular 15° C. to 30° C., preferably 18° C. to 28° C., and/under the influence of environmental moisture. Thus, industrial composting may be advantageously not necessary.

Another aspect of the present invention relates to the use of a transient copolymer comprising at least two different macromers,
wherein a first macromer is a polyester selected from the group consisting of polyethylene terephthalate, polytrimethylene terephthalate, polyethylene furanoate, polybutylene terephthalate, polybutylene succinate, polybutylene adipate terephthalate, poly(butylene succinate-co-adipate), polyethylene succinate, polybutylene adipate, and mixtures thereof;
wherein a second macromer is a condensation polymer prepared by polymerizing one or more monomers selected from the group consisting of aliphatic diols, aliphatic diamines, aliphatic dicarboxylic acids, aliphatic hydroxy acids, aliphatic amino acids and/or acetylated modifications thereof;
wherein the molar ratio of the first macromer to the second macromer is more than 4:1, and preferably ranges between 9:2 and 50:1;
   in the preparation of a bristle, textile product, personal care product, sports product, leisure product, tire, seal, or fishing equipment.

It should be understood that (preferred) embodiments of the transient copolymer, method for preparing said transient copolymer, and article comprising said transient copolymer according to aspects of the present invention, and associated advantages thereof, can be (preferred) embodiments of the use according to another aspect of the invention and vice versa.

The present invention further encompasses the use of the copolymer as disclosed herein for preparing a product or article as disclosed herein.

### EXAMPLES

### Methodology

The following describes the materials and methods used for all examples unless otherwise stated.

### Example 1

A transient copolymer according to an aspect of the invention was prepared by polycondensation of a first macromer and a second macromer.

The first macromer was a PET macromer obtained by charging terephthalic acid (1.0 mol) and ethylene glycol (1.3 mol) into a reactor operated at a temperature of 190° C. and a pressure of 5 MPa. After esterification of the acid and diol compound for 3 to 4 hours, the reaction was quenched by cooling. The second macromer was a poly(butylene dodecanedioic acid) obtained by charging dodecanedioic acid (0.10 mol) and 1,4-butanediol (0.11 mol) into a reactor, and heating the resulting mixture to 165° C. under mechanical agitation and N₂ atmosphere. The mixture was further heated gradually to a temperature between 210° C. and 235° C. for esterification of the acid and diol compound. The reaction was performed under continuous water removal for 3 hours (until no more water was removed).

The obtained macromers were polycondensated towards a transient copolyester by charging the PET macromer into a flask and softening it at 245° C. under N₂ flow and agitation. Subsequently, the poly(butylene dodecanedioic acid) macromer was added to the flask, and after 10 minutes of mechanical agitation a Ti(BuO)₄ catalyst was added. The prepared mixture was then reacted at a temperature of 245° C. under 0.5 mmHg vacuum for 8 hours.

### Example 2

Another transient copolymer according to an aspect of the invention was prepared by polycondensation of another first macromer and second macromer.

The first macromer was a PET macromer obtained by charging terephthalic acid (1.0 mol) and ethylene glycol (1.3 mol) into a reactor operated at a temperature of 190° C. and a pressure of 5 MPa. After esterification of the acid and diol compound for 3 to 4 hours, the reaction was quenched by cooling. The second macromer was a poly(butylene dimer fatty acid) obtained by charging dimer fatty acid (0.22 mol) and 1,4-butanediol (0.23 mol) into a reactor, and heating the resulting mixture to 155° C. under mechanical agitation and N₂ atmosphere. The mixture was further heated gradually to a temperature between 200° C. and 220° C. for esterification of the acid and diol compound. The reaction was performed under continuous water removal for 3 hours (until no more water was removed).

The obtained macromers were polycondensated towards a transient copolyester by charging the PET macromer into a flask and softening it at 245° C. under N₂ flow and agitation. Subsequently, the poly(butylene dodecanedioic acid) macromer was added to the flask, and after 10 minutes of mechanical agitation a Ti(BuO)₄ catalyst was added. The prepared mixture was then reacted at a temperature of 235° C. under 0.5 mmHg vacuum for 8 hours.

1. A transient copolymer comprising at least two different macromers:
i. wherein a first macromer is a polyester selected from polyethylene terephthalate, polytrimethylene terephthalate, polyethylene furanoate, polybutylene terephthalate, polybutylene succinate, polybutylene adipate terephthalate, poly(butylene succinate-co-adipate), polyethylene succinate, polybutylene adipate, and mixtures thereof;
ii. wherein a second macromer is a condensation polymer prepared by polymerizing one or more monomers selected from aliphatic diols, aliphatic diamines, aliphatic dicarboxylic acids, aliphatic hydroxy acids, aliphatic amino acids and/or acetylated modifications thereof; and
iii. wherein the molar ratio of the first macromer to the second macromer is more than 4:1.

2. The transient copolymer according to claim 1, wherein the molar ratio of the first macromer to the second macromer ranges between 5:1 and 15:1.

3. The transient copolymer according to claim 1, wherein the second macromer is a condensation polymer prepared by polymerizing one or more aliphatic diols or aliphatic diamines comprising 3 to 36 carbon atoms, and one or more linear aliphatic dicarboxylic acids comprising 7 to 10 carbon atoms.

4. The transient copolymer according to claim 1, wherein the second macromer is a condensation polymer prepared by polymerizing one or more aliphatic diols or aliphatic diamines comprising 3 to 36 carbon atoms and one or more branched aliphatic dicarboxylic acids comprising 3 to 36 carbon atoms.

5. The transient copolymer according to claim 1, wherein the one or more aliphatic diols are linear aliphatic diols selected from 1,5-pentanediol, 1,6-hexanediol, 1,7-heptanediol, 1,8-octanediol, 1,9-nonanediol, 1,10-decanediol, and mixtures thereof; and/or branched aliphatic diols selected from the group consisting of alkylated or arylated 1,2-ethanediol, 1,3-propanediol, 1,4-butanediol, pentanediol, 1,6-hexanediol, 1,7-heptanediol, 1,8-octanediol, 1,9-nonanediol, 1,10-decanediol, and mixtures thereof.

6. The transient copolymer according to claim 1, wherein the one or more aliphatic diamines are linear aliphatic diamines selected from 1,5-pentanediamine, 1,6-hexanediamine, 1,7-heptanediamine, 1,8-octanediamine, 1,9-nonanediamine and/or 1,10-decanediamine, and mixtures thereof; and/or branched aliphatic diamines selected from the group consisting of 1,5-pentanediamine, 1,6-hexanediamine, 1,7-heptanediamine, 1,8-octanediamine, 1,9-nonanediamine and/or 1,10-decanediamine, and mixtures thereof.

7. The transient copolymer according to claim 1, wherein the one or more aliphatic dicarboxylic acids are linear aliphatic dicarboxylic acids selected from heptanedioic acid, octanedioic acid, nonanedioic acid, decanedioic acid, and mixtures thereof; and/or branched aliphatic dicarboxylic acids selected from alkylated malonic acid, alkylated succinic acid, alkylated pentanedioic acid, alkylated adipic acid, alkylated heptanedioic acid, alkylated octanedioic acid, alkylated nonanedioic acid, alkylated decanedioic acid, alkylated undecanedioic acid, alkylated dodecanedioic acid, alkylated tridecanedioic acid, alkylated hexadecanedioic, alkylated octadecanedioic acid, dimer fatty diacids, and mixtures thereof.

8. The transient copolymer according to claim 1, wherein the one or more aliphatic hydroxy acids are selected from 2-hydroxy-propanoic acid, 3-hydroxy-propanoic acid, 3-hydroxy-butyric acid, 4-hydroxy-butyric acid, 3-hydroxy-pentanoic acid, 4-hydroxy-pentanoic acid, 5-hydroxy-pentanoic acid, and mixtures thereof.

9. The transient copolymer according to claim 1, wherein the one or more aliphatic amino acids are selected from 2-amino-propanoic acid, 3-amino-propanoic acid, 3-amino-butyric acid, 4-amino-butyric acid, 4-amino-pentanoic acid, 5-amino-pentanoic acid, 6-amino-hexanoic acid, 9-amino-stearic acid, 9-aminomethyl-stearic acid, 10-amino-stearic acid, 10-aminomethyl-stearic acid, 11-amino-undecanoic acid, 12-amino-dodecanoic acid, 12-amino-stearic acid, and mixtures thereof.

10. A method for preparing a transient copolymer according to claim 1, wherein the method comprises the steps of:
a) preparing a first macromer, wherein the first macromer is a polyester selected from polyethylene terephthalate, polytrimethylene terephthalate, polyethylene furanoate, polybutylene terephthalate, polybutylene succinate, polybutylene adipate terephthalate, poly(butylene succinate-co-adipate), polyethylene succinate, polybutylene adipate, and mixtures thereof;
b) preparing a second macromer by polymerizing one or more monomers selected aliphatic diols, aliphatic diamines, aliphatic dicarboxylic acids, aliphatic hydroxy acids, aliphatic amino acids and/or acetylated modifications thereof; and
c) contacting the first macromer and second macromer in a molar ratio of first macromer to second macromer of more than 4:1, thereby obtaining the transient copolymer.

11. The method according to claim 10, wherein step a) comprises polymerizing the corresponding monomers, or depolymerization of the corresponding polyester to lower molecular weight polyester, thereby obtaining the first macromer.

12. The method according to claim 10, wherein step c) comprises the steps of:
i. heating the first macromer to a temperature of 10 to 30° C. above its softening point under inert conditions, thereby softening the first macromer;
ii. adding the second macromer to the softened first macromer; and
iii. reacting the first macromer with the second macromer.

13. The method according to claim 12, wherein step iii is performed in the presence of a catalyst.

14. An article comprising the transient copolymer according to claim 1, wherein the article is a bristle, textile product, personal care product, sports product, leisure product, tire, seal, or fishing equipment.

15. (canceled)

16. A method for preparing an article comprising the transient copolymer according to claim 1, the method comprising mixing the article with the transient copolymer in a horizontal or vertical mixer, thereby producing the article, wherein the article is selected from a bristle, a textile product, a personal care product, a sport product, a leisure product, a tire, a seal product, or a fishing equipment product.

17. The transient copolymer according to claim 1, wherein the molar ratio of the first macromer to the second macromer ranges between 9:2 and 50:1.

18. The method according to claim 10, wherein contacting the first macromer and second macromer in a molar ratio of first macromer to second macromer ranging between 9:2 and 50:1, thereby obtaining the transient copolymer.

19. The method according to claim 10, wherein polymerizing the corresponding monomers comprises contacting ethylene glycol and/or 1,4-butanediol with one or more compounds selected from terephthalic acid, 2,5-furanedicarboxylic acid, succinic acid, adipic acid, or salt, ester, or anhydride derivatives thereof.

20. The method according to claim 13, wherein the catalyst is titanium (IV) butoxide or zinc acetate.
